(19) United States
(12) Patent Application Publication
(10) Pub. No.: US 2025/0289015 A1
(43) Pub. Date: Sep. 18, 2025

(54) Hand-held high-pressure cleaning device

(71) Applicant: Andreas Stihl AG & Co. KG, Waiblingen (DE)

(72) Inventors: Michael Renz, Stuttgart (DE); Mario Häfele, Wüstenrot (DE)

(73) Assignee: Andreas Stihl AG & Co. KG, Waiblingen (DE)

(21) Appl. No.: 19/076,882

(22) Filed: Mar. 11, 2025

(30) Foreign Application Priority Data
Mar. 13, 2024 (EP) 24163255.3

(51) Int. Cl. B05B 9/04; B05B 12/00; B08B 3/02; H01M 10/48

(52) U.S. Cl. CPC B05B 9/0413; B05B 9/0426; B05B 12/002; B08B 3/026; H01M 10/488; H01M 2220/30

(57) ABSTRACT

A hand-held high-pressure cleaning device includes a housing. The housing has a housing outer wall. A pump for generating high pressure in a cleaning fluid and a motor for driving the pump are arranged in the housing. The high-pressure cleaning device includes a display element visible from outside the housing in the region of the housing outer wall. The display element can be illuminated by a light source arranged in the housing. An electronics module having an electronics housing is arranged in the housing. A control unit is arranged in the electronics housing. The light source is arranged on the electronics module. A channel for guiding light from the light source to the display element is arranged between the electronics module and the display element.

### CROSS-REFERENCE TO RELATED APPLICATION

This application claims the benefit of European Patent Application EP 24163255.3, filed on Mar. 13, 2024, the content of which is incorporated in its entirety.

### TECHNICAL FIELD

The disclosure relates to a hand-held high-pressure cleaning device, which may also be referred to as a pressure washer.

### BACKGROUND

In conventional hand-held high-pressure cleaning devices, the installation space is usually not well utilized. This leads, on the one hand, to the volumes of the housings of these high-pressure cleaning devices being very large. This makes the devices unwieldy and difficult to guide. On the other hand, a plurality of cables are required for connecting the electronic components. Therefore, production is cost-intensive and the hand-held high-pressure cleaning device is unnecessarily heavy. Furthermore, the connecting points between cables and electronic components are susceptible to short circuits caused by fluid and breaks often occur at these points.

### SUMMARY

The disclosure is based on the object of further developing a generic hand-held high-pressure cleaning device in such a way that good utilisation of the installation space available in the housing is possible with the least possible number of cables for connecting the electronic components.

This object is solved by a hand-held high-pressure cleaning device as disclosed and claimed.

The hand-held high-pressure cleaning device includes a light source arranged on an electronics module and a channel arranged between the electronics module and a display element for guiding light from the light source to the display element. The arrangement of the light source on the electronics module opens up the possibility of wirelessly connecting the light source to the control unit of the electronics module, in particular to the electronics module. Therefore, a cable is not required between the light source and the control unit, in particular the electronics module. For example, the light source can be connected to the control unit, in particular to a printed circuit board of the control unit, by means of a solder connection or a plug-in connection. It can also be provided that the light source is designed directly on the electronics module. In particular, the light source may be an LED (Light Emitting Diode). In particular, the light source can be arranged directly on the control unit. In particular, the control unit can be a circuit board. In particular, the control unit can be a printed circuit board.

Because a channel for guiding light from the light source to the display element is arranged between the electronics module and the display element, the electronics module can be placed with a certain amount of play in the housing of the hand-held high-pressure cleaning device. This allows for flexibility and the skilful utilisation of available installation space. For example, it can be required that the electronics module be arranged away from the display element for interaction with other electronic components and/or actuating elements. The light can then easily be guided through the channel from the light source to the display element. In comparison to the prior art, a cable is not required for this. Similarly, a further circuit board, arranged away from the electronics module and on which the light source would then be arranged, is not required either. This can also save on installation space and the number of cables can be reduced.

In particular, the electronics housing is arranged at a distance from the housing outer wall. In particular, the electronics housing is arranged at a distance from the display element in the housing. In particular, the display element is a component of the housing outer wall.

The channel has an inner longitudinal end. The inner longitudinal end is assigned to the electronics housing. The channel has an outer longitudinal end. The outer longitudinal end is assigned to the display element. The channel encloses a longitudinal center axis which runs through the outer longitudinal end and the inner longitudinal end. The longitudinal center axis runs in a longitudinal direction. The channel has a channel length measured in the longitudinal direction. The light source has a light emission surface. The light emission surface has the largest source extent. The source extent is measured in particular radially to the longitudinal center axis. Advantageously, the channel length is at least 200%, in particular at least 300%, in particular at least 400% of the largest source extent. In particular, the channel length is at least 10 mm, in particular at least 20 mm. Therefore, the channel bridges a significant distance between the light source and the housing outer wall. Therefore, a significant length of cable is saved. This simplifies the construction of the high-pressure cleaning device. Furthermore, this saves costs and makes the high-pressure cleaning device less susceptible to short circuits and breaks in the power supply line

Expediently, the channel connects the display element to the light source without interruption. In particular, the channel is hollow for guiding light. However, it can also be provided that the channel is formed by a light guide, made in particular from transparent plastic.

In particular, the channel has a channel wall. Advantageously, the channel wall at least partially prevents light emission in the direction transverse to the longitudinal direction of the channel. In particular, the channel wall completely prevents the light emission in the direction transverse to the longitudinal direction of the channel. In particular, the channel wall causes less than 20% of light intensity to penetrate to the outer side of the channel as the light travels from the light source to the display element. In particular, the channel wall causes more than 70% of the light intensity to be kept in the channel as the light travels from the light source to the display element. In particular, the channel wall causes at least 70% of the light intensity of the light emitted from the light source to arrive at the display element.

Expediently, a light guide is arranged in the channel. In particular, the light guide consists of transparent plastic. In particular, the light exiting the light source is reflected at the interface between the light guide and the channel inner wall and in this manner is guided to the display element.

In particular, the light guide causes less than 20% light intensity to penetrate to the outer side of the channel as the light travels from the light source to the display element. In particular, the light guide causes more than 70% of the light intensity to be kept in the channel as the light travels from the light source to the display element. In particular, the light guide causes at least 70% of the light intensity of the light emitted from the light source to arrive at the display element.

The light can be guided from the light source to the display element in a particularly simple and cost-effective manner by the light guide. In particular, a curvy and/or angled design of the course of the channel is possible due to the light guide.

In particular, the light guide completely fills the hollow channel. Advantageously, the light guide rests directly against the channel wall. Advantageously, there is no hollow space between the light guide and the channel wall.

The housing of the hand-held high-pressure cleaning device in particular comprises a discharge opening for discharging the cleaning fluid from the housing. The cleaning fluid is discharged from the discharge opening in a discharge direction. The housing has a back end lying opposite the discharge opening in the direction opposite to the discharge direction. Expediently, the display element is arranged in the region of the back end. Therefore, the user can view the display element while cleaning fluid is being discharged in the discharge direction. In particular, the display element, in particular the display surface, points in the opposite direction to the discharge direction.

The display element is arranged in the region of the back end in particular so that the discharge direction runs transverse to a display surface of the display element. In particular, the display surface is oriented at an angle of 30° to 90°, in particular from 40° to 80°, in particular from 50° to 70°. This angle is facing towards the housing of the hand-held high-pressure cleaning device and opens in particular in the direction away from a hand grip of the housing. The operator can see the display surface particularly well due to this orientation of the display surface of the display element. Furthermore, the arrangement of the operating elements on the display surface of the display element is also possible. In particular, these operating elements can then be arranged ergonomically due to the orientation of the display surface of the display element.

In an advantageous development, the high-pressure cleaning device comprises several light sources and several channels. In particular, a channel is assigned to each of the several light sources. Therefore, different operating states of the high-pressure cleaning device can be displayed in a simple manner. For example, the charging state of a rechargeable battery pack can be specified by the number of illuminated light sources.

The motor has a motor rotational axis. Advantageously, the electronics housing is arranged in the region of the motor in relation to the direction of the motor rotational axis. In particular, the electronics housing and the motor overlap in relation to the direction of the motor rotational axis. Advantageously, the electronics housing is arranged completely inside the region of the motor in relation to the direction of the motor rotational axis. In particular, the electronics housing is arranged next to the motor in relation to the motor rotational axis in the radial direction. A compact design of the hand-held cleaning device results due to this arrangement of the electronics housing.

In particular, the high-pressure cleaning device comprises a hand grip. Advantageously, the hand grip is formed by the housing.

The motor has an underside facing towards the hand grip and an upper side facing away from the hand grip. Expediently, the electronics module is arranged on the upper side of the motor facing away from the hand grip. This results in very good utilization of the installation space.

Expediently, an operating element is arranged on the housing of the hand-held high-pressure cleaning device. In particular, a function of the high-pressure cleaning device can be controlled by means of the operating element via the control unit. Expediently, the light source can be controlled by means of the control unit. In particular, the light source can be controlled by means of the control unit, in order to display a status of the function of the high-pressure cleaning device by illuminating the display element. Due to the arrangement of the light source on the electronics module which comprises the control unit, controlling the light source is possible by the control unit in a very simple manner. Installing cables for this purpose can be dispensed with. The light source can directly contact the control unit by means of a plug-in contact or by means of a solder connection. Similarly, it can be provided that the light source, in particular in the form of an LED, is directly arranged on the control unit. In particular, the light source can be a component of a control unit designed in particular as a circuit board/printed circuit board. In particular, the light source in the form of an LED can be arranged on the control unit as a carrier, in particular vapor-deposited thereon.

The high-pressure cleaning device comprises in particular an actuating element. The actuating element is expediently mechanically actuated by means of the operating element. In particular, when actuated the actuating element sends a signal to the control unit. Advantageously, the actuating element is arranged in the electronics housing. In particular, the actuation of the actuating element takes place exclusively mechanically. Installing cables is not required to actuate the actuating element due to the mechanical actuation of the actuating element by means of the operating element. In particular, the actuating element can be directly arranged on the control unit, in particular on the control unit designed as a circuit board.

Expediently, an operating lever for actuating the motor and/or for actuating an inlet valve is arranged on the housing. Cleaning fluid can flow into the pump through the inlet valve. Advantageously, the operating lever is arranged between the motor and the inlet valve in relation to the discharge direction of the cleaning fluid from the discharge opening. A compact design of the hand-held high-pressure cleaning device is possible due to this arrangement of the operating lever between the motor and the inlet valve. The operating lever can reach both the motor as well as the inlet valve by the shortest route. Therefore, a simple and space-efficient actuation of both the motor as well as the inlet valve is possible due to the operating lever.

In particular, the hand-held high-pressure cleaning device comprises a transmission for transmitting a torque from the motor to the pump. Expediently, the transmission is arranged between the motor and the pump in relation to the discharge direction of the cleaning fluid from the discharge opening. The operating lever has a longitudinal end facing away from the hand grip. Advantageously, the longitudinal end facing away from the hand grip, for actuating the inlet valve, is arranged between the transmission and the inlet valve in relation to the discharge direction. In particular, the inlet valve is arranged before the transmission in relation to the discharge direction. In particular, the hand-held high-pressure cleaning device is designed so that the longitudinal end of the operating lever for actuating the inlet valve has to be moved in the discharge direction. In particular, the hand-held high-pressure cleaning device is designed so that the operating lever for actuating the motor has to be moved in the opposite direction to the discharge direction.

In particular, the motor of the hand-held high-pressure cleaning device is an electric motor. Expediently, the hand-held high-pressure cleaning device for supplying energy to the electric motor comprises a rechargeable battery pack. In particular, the rechargeable battery pack is arranged on the hand grip. In particular, the rechargeable battery pack is arranged at least partially in the hand grip. Expediently, a connection element for connecting an external fluid source is arranged on the housing outer wall of the housing.

### BRIEF DESCRIPTION OF THE DRAWINGS

An exemplary embodiment of the invention is explained in the following using the drawings.

FIG. 1 is a perspective illustration of a hand-held high-pressure cleaning device.

FIG. 2 is a sectional illustration of a section through the hand-held high-pressure cleaning device from FIG. 1, wherein the section plane runs through a channel to guide light from a light source to a display element and a supply line valve is not actuated by an operating lever.

FIG. 3 is the sectional illustration from FIG. 2, wherein the supply line valve is actuated by the operating lever.

FIG. 4 is an enlarged illustration of a detail from FIG. 2.

FIG. 5 is a partial sectional perspective illustration of the hand-held high-pressure cleaning device from FIG. 1, wherein the section plane intersects the channel.

FIG. 6 is a perspective illustration of a detail of a housing half of a housing of the high-pressure cleaning device from FIG. 1.

FIG. 7 is a detailed illustration of a section having a section plane parallel to the section plane from FIGS. 2 and 3, wherein the section plane runs through an operating element.

FIG. 8 is a perspective illustration of the section from FIG. 7.

FIG. 9 is a perspective sectional illustration analogous to FIG. 8, but with a section plane offset parallel thereto, which intersects the channel.

FIG. 10 is a perspective illustration of the electronics module of the hand-held high-pressure cleaning device from FIG. 1.

FIG. 11 is a perspective sectional illustration of a section through the electronics module from FIG. 10, wherein the section plane runs through an actuating element.

### DETAILED DESCRIPTION

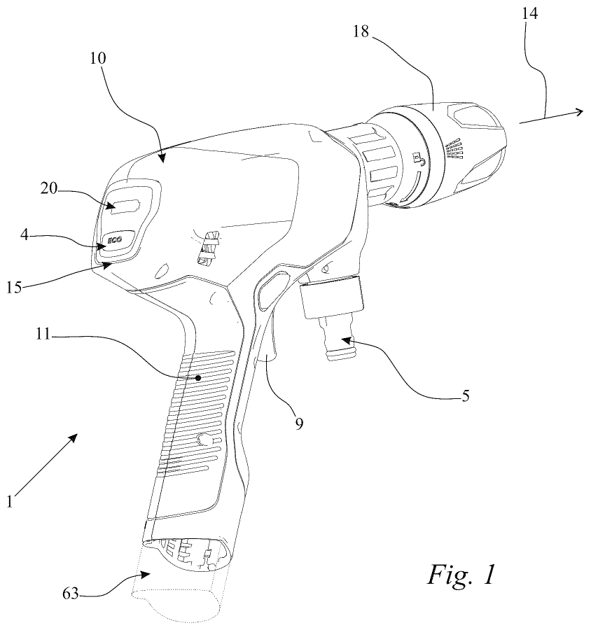

FIG. 1 shows a high-pressure cleaning device 1. The high-pressure cleaning device 1 is used to spray a cleaning fluid that has been pressurized by the high-pressure cleaning device 1. The high-pressure cleaning device 1 can be hand-held when used as intended.

The high-pressure cleaning device 1 can pressurize the cleaning fluid to a pressure of at least 10 bar, in particular of at least 15 bar, in particular of at least 30 bar, in particular of at least 100 bar. In particular, the high-pressure cleaning device 1 can pressurize the cleaning fluid to a pressure of at most 600 bar, in particular at most 500bar.

The hand-held high-pressure cleaning device 1 comprises a housing 10. The high-pressure cleaning device 1 comprises a hand grip 11. The hand grip 11 is in particular substantially rod-shaped. The hand grip 11 extends along a hand grip longitudinal axis 19. The hand grip 11 can be gripped and held with a single hand. The high-pressure cleaning device 1 can be guided and operated by the hand grip 11 with a single hand. The high-pressure cleaning device 1 is designed so that it can be guided when gripping the hand grip 11 with a single hand. In the exemplary embodiment, the hand grip 11 is formed by the housing 10. The hand grip 11 is an integral component of the housing 10. The high-pressure cleaning device 1 has an operating lever 9. The operating lever 9 can be operated with the same hand that is used to grip the hand grip 1 when the hand grip 11 is being gripped. In particular, the operating lever 9 can be operated with a two-jointed finger.

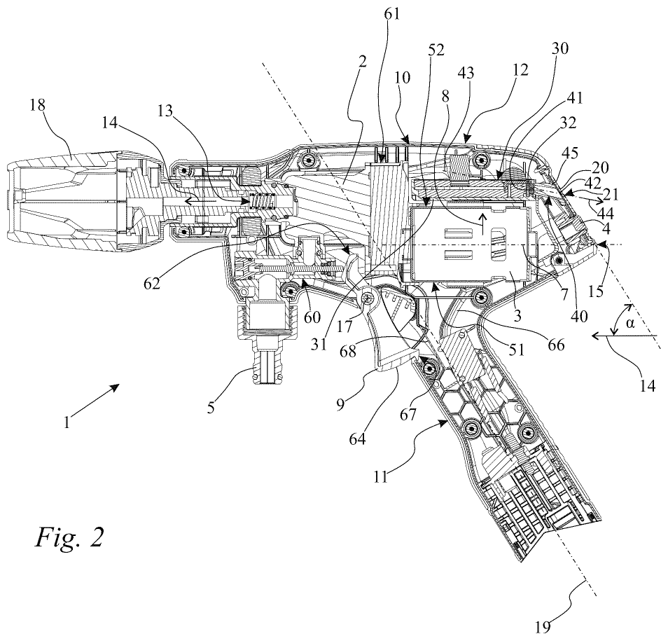

As illustrated in FIG. 2, the high-pressure cleaning device 1 comprises a motor 3 and a pump 2. The pump 2 serves to generate high pressure in a cleaning fluid. For this purpose, the pump 2 has a piston that can be moved axially, not illustrated. The cleaning fluid is pressurized in piston chambers. The pump 2 serves to convey the cleaning fluid to an ejection opening 13. The motor 3 serves to drive the pump 2. The motor 3 is arranged in the housing 10. The pump 2 is arranged in the housing 10. The housing 10 has a housing outer wall 12.

The motor 3 is in particular an electric motor. In the exemplary embodiment, the high-pressure cleaning device 1 for supplying energy to the electric motor comprises a rechargeable battery pack 63, illustrated schematically in FIG. 1. In the exemplary embodiment, the rechargeable battery pack 63 is arranged on the hand grip 11, in particular in the hand grip 11. The rechargeable battery pack 63 is plugged into the hand grip 11. The rechargeable battery pack 63 protrudes from the hand grip 11.

As illustrated in FIG. 1, the high-pressure cleaning device 1 comprises a display element 20. The display element 20 can be visible from outside the high-pressure cleaning device 1, in particular from outside the housing 10. The display element 20 is arranged in the region of the housing outer wall 12. In particular, the display element 20 is a component of the housing outer wall 12. In particular, the display element 20 forms a part of the housing outer wall 12.

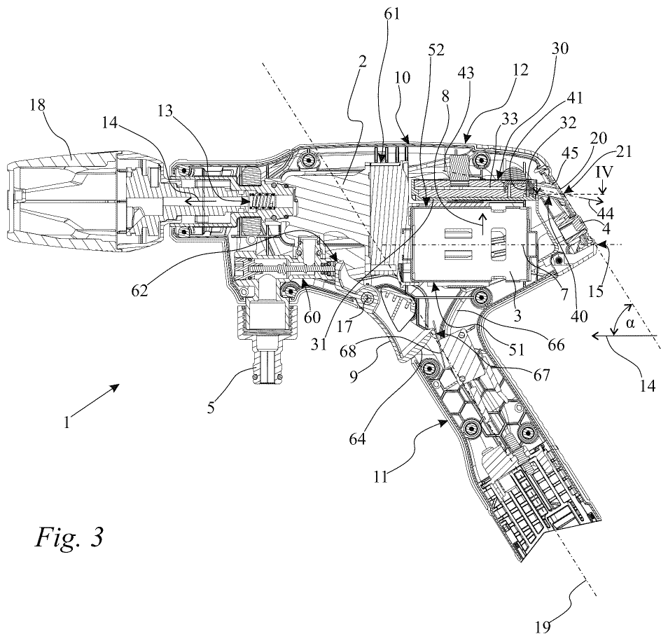

As illustrated in FIGS. 2 and 3, the high-pressure cleaning device 1 has the discharge opening 13. The discharge opening 13 is formed by the housing 10. The discharge opening 13 serves to discharge the cleaning fluid from the housing 10. In the exemplary embodiment, an ejection spray head 18 is arranged on the discharge opening 13. The ejection spray head 18 has a nozzle. The cleaning fluid is discharged from the discharge opening 13 of the housing 10 and enters into the ejection spray head 18. The cleaning fluid is sprayed from the high-pressure cleaning device 1 by the ejection spray head 18, in particular through the nozzle. The cleaning fluid is sprayed in a discharge direction 14 when the cleaning fluid is sprayed from the housing 10, in particular from the high-pressure cleaning device 1. The discharge direction 14 runs in the direction of a longitudinal axis of the high-pressure cleaning device 1. The motor 3 has a motor rotational axis 7. The discharge direction 14 runs parallel to the motor rotational axis 7 in the exemplary embodiment. As illustrated in FIG. 1, the high-pressure cleaning device 1, in particular the housing 10 has a back end 15. The discharge direction 14 points in the direction away from the back end 15 towards the discharge opening 13.

As illustrated in FIG. 2, the high-pressure cleaning device 1 comprises a light source 32. The light source 32 is arranged in the housing 10. The display element 20 can be illuminated by means of the light source 32. The display element 20 is at least partially light-permeable in the exemplary embodiment. The display element 20 is at least partially translucent in the exemplary embodiment. The display element 20 is at least partially transparent in the exemplary embodiment. The light emitted from the light source 32 can exit from the high-pressure cleaning device 1 through the display element 20.

The hand-held high-pressure cleaning device 1 comprises an electronics module 30. The electronics module 30 has an electronics housing 31, as illustrated in FIG. 2. The electronics housing 31 is arranged inside the housing 10. The electronics module 30 comprises a control unit 33. The control unit 33 is arranged in the electronics housing 31.

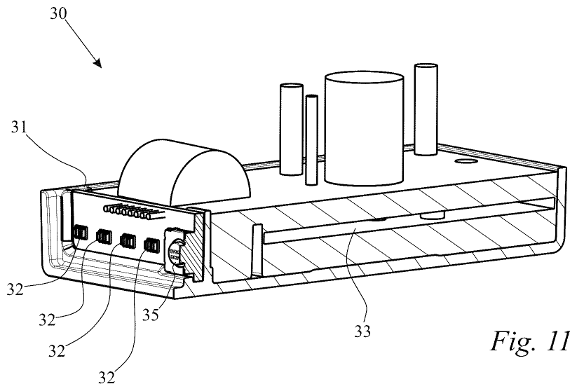

The light source 32 is arranged on the electronics module 30. As illustrated in FIGS. 10 and 11, the light source 32 forms a part of the outer wall of the electronics housing 31. In the exemplary embodiment, the light source 32 is a component of the electronics module 30. In the exemplary embodiment, the light source 32 is a component of the electronics housing 31.

As illustrated in FIG. 2, the high-pressure cleaning device 1 has a channel 40. The channel 40 serves to guide light from the light source 32 to the display element 20. The channel 40 is arranged between the electronics module 30 and the display element 20. The light emitted from the light source 32 can exit from the high-pressure cleaning device 1 through the channel 40 and through the display element 20.

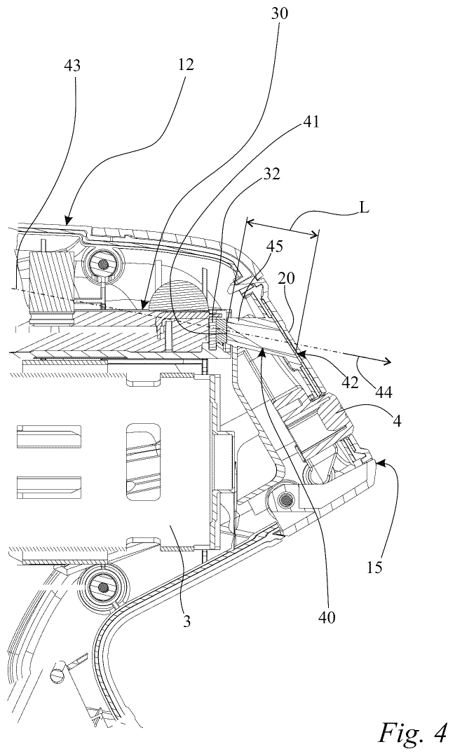

FIG. 4 shows the channel 40 in detail. In the exemplary embodiment, the channel 40 is hollow for guiding light. A channel wall 45 of the channel 40 delimits the channel 40. However, it can also be provided that the channel 40 consists of a solid material. For example, the channel 40 may be a light guide. In particular, the channel 40 can consist of transparent plastic. In the exemplary embodiment, the channel 40 is hollow, and the channel wall 45 at least partially prevents light emission through the channel wall 45. The channel 40 is substantially tube-shaped.

The channel 40 has an inner longitudinal end 41. The inner longitudinal end 41 is assigned to the electronics housing 31. The inner longitudinal end 41 is facing towards the electronics housing 31. The inner longitudinal end 41 rests directly against the electronics housing 31, in particular against the light source 32. The channel 40 has an outer longitudinal end 42. The outer longitudinal end 42 is assigned to the display element 20. The outer longitudinal end 42 of the channel 40 rests directly against the display element 20. The outer longitudinal end 42 rests directly against the inner side of the display element 20. The channel 40 encloses a longitudinal center axis 43. In the exemplary embodiment, the channel wall 45 runs in a closed configuration around the longitudinal center axis 43 in relation to a circumferential direction. The longitudinal center axis 43 runs through the outer longitudinal end 42 and through the inner longitudinal end 41 in a longitudinal direction 44. The longitudinal center axis 43 runs through a centroid of the inner longitudinal end 41 of the channel 40 and through a centroid of the outer longitudinal end 42 of the channel 40. The longitudinal center axis 43 extends in a straight line in the exemplary embodiment. The longitudinal center axis 43 extends in a longitudinal direction 44. The longitudinal direction 44 points from the light source 32 in the direction of the display element 20.

In the exemplary embodiment, the channel wall 45 is completely closed from the inner longitudinal end 41 up to the outer longitudinal end 42, in particular in the longitudinal direction 44, in particular along the longitudinal center axis 43. The channel wall 45 delimits the channel 40 in the direction radial to the longitudinal center axis 43, in particular in the direction radial to the longitudinal direction 44.

In the exemplary embodiment, the channel wall 45 of the channel 40 at least partially prevents light emission in the direction transverse, in particular perpendicular to the longitudinal direction 44 of the channel 40. The light intensity of the light emitted by the light source 32 and entering into the channel 40 is attenuated in the channel 40 until it reaches the light of the display element 20, at most by 20%, in the exemplary embodiment at most by 10%. In particular, the channel wall 45 is opaque.

In the exemplary embodiment, a light guide is arranged in the channel 40. In particular, the light guide consists of transparent plastic. The light guide rests with its outer side against the channel wall 45. The light of the light source 32 is reflected, in particular totally reflected, at the interface between the light guide and the channel wall 45. In particular, the light guide is full of solid material. In particular, the light guide completely fills the channel 40. In particular, no hollow space is formed between the light guide and the channel wall 45, in particular the inner side of the channel wall 45.

The electronics housing 31 is arranged at a distance from the display element 20. The electronics housing 31 is arranged at a distance from the housing outer wall 12. The electronics housing 31 is arranged in the housing 10 of the high-pressure cleaning device 1. The channel 40 connects the light source 32 to the display element 20. The channel 40 connects the display element 20 to the light source 32 without interruption.

The channel 40 has a channel length L, measured in the longitudinal direction 44. The channel length L is at least 10 mm. In the exemplary embodiment, the channel length L is at least 20 mm.

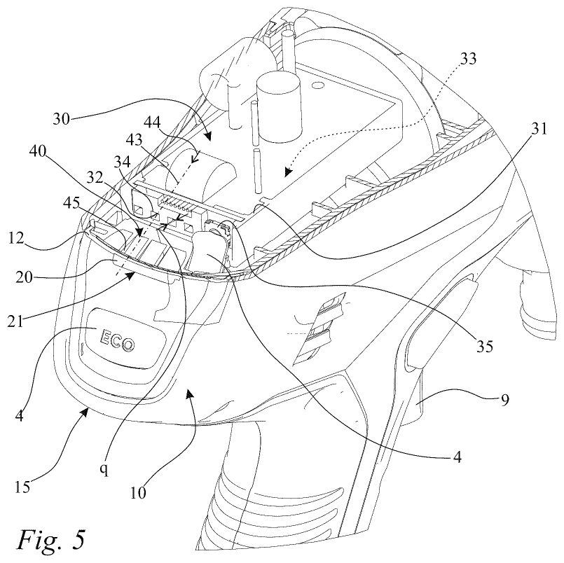

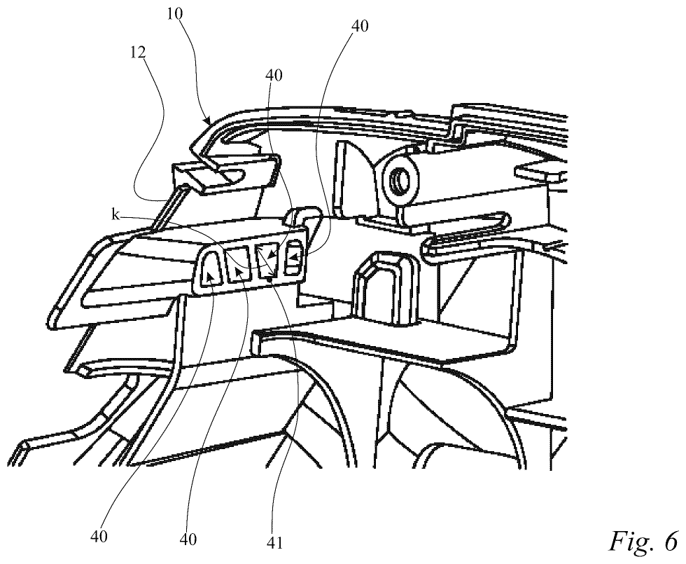

As illustrated in FIG. 5 and/or FIG. 10, the light source 32 has a light emission surface 34. As illustrated in FIG. 6, the channel 40 has a light entry surface 46 on its inner longitudinal end 41. In the exemplary embodiment, the size of the light emission surface 34 corresponds to the size of the light entry surface 46. The light emission surface 34 has the largest source extent q, illustrated in FIG. 5. The largest source extent q is the largest extent of the light emission surface 34. The largest source extent q is measured in the direction transverse to the longitudinal center axis 43. The largest source extent q corresponds to the diagonal of the rectangular light emission surface 34, in the exemplary embodiment. The channel length L, illustrated in FIG. 4, is at least 200%, in particular at least 300%, in the exemplary embodiment at least 400% of the largest source extent q illustrated in FIG. 5.

In FIG. 6, the largest channel extent k of the light entry surface 46 of the channel 40 is marked. The largest channel extent k is the largest extent of the light entry surface 46. The largest channel extent k is measured in the direction transverse to the longitudinal center axis 43. The channel length L of the channel 40 is at least 200%, in particular at least 300%, in particular at least 400% of the largest channel extent k.

As illustrated in FIGS. 2 and 3, the discharge opening 13 is opposite the back end 15 in the direction of the discharge direction 14. The display element 20 is arranged in the region of the back end 15. In the exemplary embodiment, the display element 20 is arranged so that the discharge direction 14 runs transverse to a display surface 21 of the display element 20. In the exemplary embodiment, the display surface 21 of the display element 20 is flat. The display surface 21 extends in one plane. However, it can also be provided that the display surface is curved. The display surface 21 runs diagonal to the discharge direction 14. The discharge direction 14 is oriented to the display surface 21 at an angle α, in particular in a section plane, which includes the longitudinal center axis 43 and runs perpendicular to the light emission surface 34. The angle a opens in the direction towards the housing 10 and in the direction away from the hand grip 11. The angle a is from 10° to 90°, in particular from 20° to 80°, in particular from 30° to 70°, in the exemplary embodiment from 40° to 60°. The display surface 21 runs in particular in a section plane, which includes the longitudinal center axis 43 and runs perpendicular to the light emission surface 34, substantially parallel to the hand grip longitudinal axis 19. The display surface 21 points in the opposite direction to the discharge direction 14. The display surface 21 is facing towards the operator during operation of the high-pressure cleaning device 1.

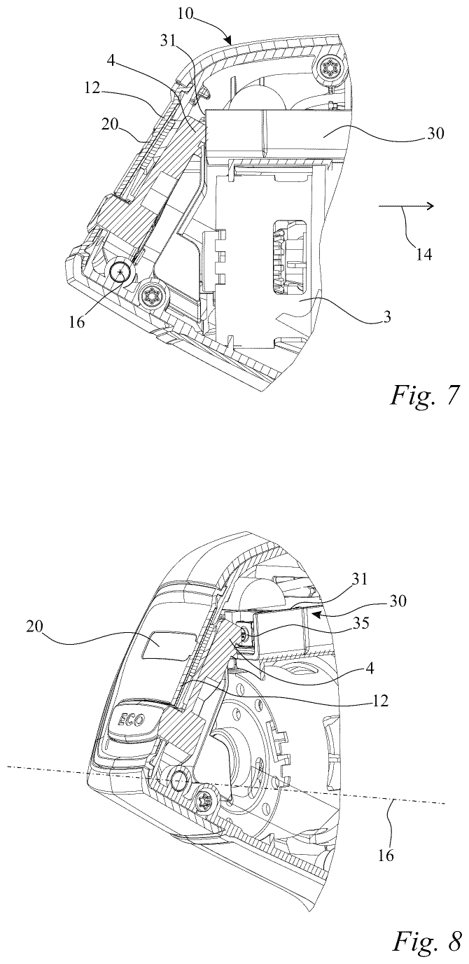

The high-pressure cleaning device 1 comprises an operating element 4. The operating element 4 is arranged on the housing 10. In the exemplary embodiment, the operating element 4 is arranged in the region of the display element 20. In the exemplary embodiment, the operating element 4 is arranged in the region of the display surface 21. An operating surface of the operating element 4 extends in the direction parallel to the display surface 21. Therefore, convenient operation of the operating element 4 by a user is possible. The operating element 4, in particular the operating surface of the operating element 4, is also facing towards the user during operation of the high-pressure cleaning device 1. This results in ergonomic operation of the high-pressure cleaning device 1. In particular, the operating surface is oriented diagonal to the discharge direction 14. In particular, the operating surface is oriented at an angle a to the discharge direction 14. In particular, the operating surface is facing towards the user during operation of the high-pressure cleaning device 1. The operating element 4 can be operated by pressing, in particular by pressing the operating surface. The operating element 4 is pivotably mounted around a pivot axis 16, illustrated in FIGS. 7 and 8. In particular, the operating device 4 is pivotably mounted on the housing 10. The operating element 4 is pivoted around the pivot axis 16 by pressing the operating surface of the operating element 4.

A function of the high-pressure cleaning device 1 can be controlled by means of the operating element 4 via the control unit 33. The function of the high-pressure cleaning device 1 may be a boost function, for example, or an eco mode of the high-pressure cleaning device 1. In eco mode, less power is drawn from the battery 63 for operation of the motor 3. In eco mode, the motor 3 is operated at a lower speed than normal. In boost mode, more power is drawn from the battery 63 for operation of the motor 3. In boost mode, the motor 3 is operated at a higher speed than normal.

The high-pressure cleaning device 1 comprises an actuating element 35, illustrated in FIG. 8. The actuating element 35 can be actuated mechanically by means of the operating element 4. The operating element 4 is pivoted around the pivot axis 16 by pressing the operating element 4 via the operating surface of the operating element 4 and thereby actuates the actuating element 35. The operating surface of the operating element 4 is arranged between the pivot axis 16 and the actuating element 35. The actuating element 35 is arranged on, in particular in electronics housing 31. The actuating element 35 is arranged at a distance from the housing outer wall 12. When actuating the actuating element 35, the actuating element 35 sends a signal to the control unit 33. The actuating element 35 can be actuated purely mechanically by pressing the operating element 4.

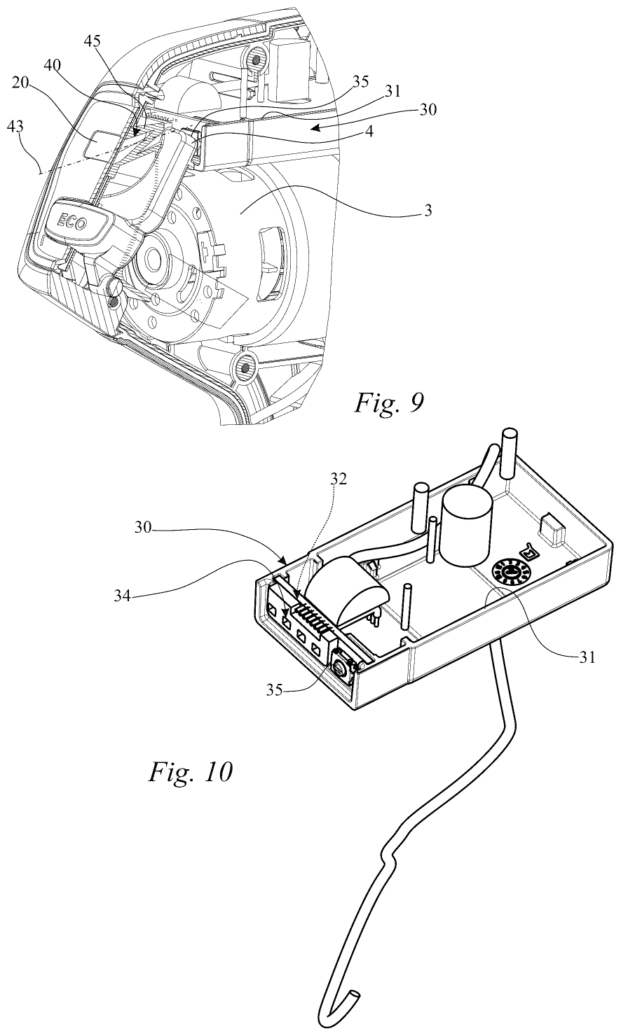

The operating element 4 is arranged between the housing outer wall 12 and the electronics module 30. The operating element 4 is arranged next to the channel 40 in the direction transverse to the discharge direction 14. Due to the diagonal orientation of the display surface 21, which forms a part of the housing outer wall 12, in relation to the discharge direction 14, the operating element 4 can be arranged in the housing 10 in a space-saving manner. FIGS. 7 to 9 illustrate this in particular.

It can be provided that the light source 32 can be controlled by means of the control unit 33, in order to display a status of the function, in particular the function that can be controlled by the operating element 4, by illuminating the display element 20.

In the exemplary embodiment, the display element 20 displays the charging status of the rechargeable battery pack 63. As illustrated in FIG. 6, the high-pressure cleaning device 1 comprises several channels 40. As illustrated in FIG. 11, the high-pressure cleaning device 1 comprises several light sources 32. A channel 40 is assigned to each of the several light sources 32. The above description of the channel 40 applies to each of the channels 40. The same applies for the light sources 32.

In order to display the state of charge of the rechargeable battery pack 63, depending on the state of charge, a different number of light sources 32 illuminate the display element 20.

As illustrated in FIGS. 2 and 3, the electronics housing 31 is arranged in the region of the motor 3 in relation to the direction of the motor rotational axis 7. The electronics housing 31 overlaps the motor 3 in relation to the direction of the motor rotational axis 7. The electronics housing 31 overlaps the motor 3 in relation to the discharge direction 14. In the exemplary embodiment, the electronics housing 31 is arranged completely in the region of the motor 3 in relation to the discharge direction 14. In the exemplary embodiment, the electronics housing 31 is arranged completely in the region of the motor 3 in relation to the direction of the motor rotational axis 7. The electronics housing 31 is arranged next to the motor 3 in relation to the motor rotational axis 7 in the radial direction 8. The motor 3 has an underside 51 facing towards the hand grip 11. The motor 3 has an upper side 52 facing away from the hand grip 11. The electronics module 30 is arranged on the upper side 52 of the motor 3 facing away from the hand grip 11. The electronics module 30, in particular the electronics housing 31, is arranged in the region, in particular completely in the region of the pump 2, in relation to the radial direction 8.

The high-pressure cleaning device 1 comprises a transmission 61 for transmitting a torque from the motor 3 to the pump 2. The transmission 61 is arranged between the motor 3 and the pump 2 in relation to the discharge direction 14 of the cleaning fluid. The electronics module 30, in particular the electronics housing 31, is arranged completely in the region of the transmission 61 in relation to the radial direction 8.

The operating element 4 is arranged in the region of the motor 3, in relation to the radial direction 8. The operating element 4 is arranged in the region of the electronics module 30, in particular the electronics housing 31, in relation to the radial direction 8. The operating element 4 is arranged behind the motor 3 in relation to the discharge direction 14. The operating element 4 is arranged behind the electronics module 30, in particular behind the electronics housing 31, in relation to the discharge direction 14.

The electronics module 30 comprises a single electronics housing 31. The entire control electronics of the high-pressure cleaning device 1 is accommodated in the single electronics module 30. This enables simple production of the high-pressure cleaning device 1. The control electronics can be easily protected from moisture by the central arrangement of the control electronics in a single electronics module 30.

FIG. 10 shows that the electronics housing 31 is substantially trough-shaped. A side wall of the electronics housing 31 is formed by the light source 32, in particular by a circuit board of the light source 32. The light source 32 points in the opposite direction to the discharge direction 14.

As illustrated in FIG. 11, the control unit 33 is encapsulated in a potting compound. The electronics housing 31 forms a space for receiving the potting compound and the control unit 33. One part of the housing wall of the electronics housing 31 is formed by the light source 32, in particular by a carrier of the light source 32. In particular, LEDs of the light source 32 are arranged on the carrier. The carrier forms a side wall of the electronics housing 31. This can also be seen in FIG. 10. The potting compound is in direct contact with the carrier of the light source 32.

The light source 32 is connected electrically directly to the control unit 33, in particular to the printed circuit board of the control unit 33. The light source 32 is wirelessly connected electrically to the control unit 33, in particular to the printed circuit board of the control unit 33. In the exemplary embodiment, the light source 32, in particular the printed circuit board of the light source 32, is connected to the control unit 33, in particular to the printed circuit board of the control unit 33, by a solder connection. It can also be provided that the light source 32, in particular the printed circuit board of the light source 32, is connected electrically by a plug-in connection to the control unit 33, in particular to the printed circuit board of the control unit 33.

The high-pressure cleaning device 1 comprises an operating lever 9, illustrated in FIGS. 2 and 3. The operating lever 9 serves to actuate the motor 3 and/or to actuate an inlet valve 60. Cleaning fluid can flow into the pump 2 through the inlet valve 60. In the closed state of the inlet valve 60, the supply of cleaning fluid to the pump 2 is interrupted. In the exemplary embodiment, the operating lever 9 serves to actuate the motor 3 and the inlet valve 60. The operating lever 9 is arranged between the motor 3 and the inlet valve 60 in relation to the discharge direction 14. The inlet valve 60 is arranged fluidically between the pump 2 and a connection element 5. The connection element 5 serves to connect an external fluid source. The connection element 5 serves to connect a hose to the high-pressure cleaning device 1, for example. The external fluid source can be a domestic water connection, for example. However, the external fluid source may also be a water reservoir, for example a water tank or a pool. The connection element 5 is arranged before the hand grip 11 in relation to the discharge direction 14. The connection element 5 is arranged below the underside 51 of the motor 3, in relation to the radial direction 8 of the motor rotational axis 7. The connection element 5 is arranged before the pump 2 in relation to the discharge direction 14. The connection element 5 is arranged at the height of the discharge opening 13 in relation to the discharge direction 14.

The operating lever 9 can be pivoted around an operating lever pivot axis 17. The operating lever 9 is pivotably mounted on the housing 10 of the high-pressure cleaning device 1. Depending on the pivot position of the operating lever 9, the inlet valve 60 is closed or open. FIG. 2 shows the inlet valve 60 in a closed position. FIG. 3 shows the inlet valve 60 in an open position.

The operating lever 9 has a longitudinal end 62 facing away from the hand grip 11. The longitudinal end 62 of the operating lever 9 is arranged between the motor 3 and the inlet valve 60 in relation to the discharge direction 14. The longitudinal end 62 is arranged between the transmission 61 and the inlet valve 60 in relation to the discharge direction 14. The inlet valve 60 can be actuated by means of the longitudinal end 62 of the operating lever 9, in particular actuated purely mechanically. When the longitudinal end 62 is pivoted forwards in the discharge direction 14, the inlet valve 60 is pressed in the direction of its open position. When the longitudinal end 62 is pivoted counter to the discharge direction 14 around the operating lever pivot axis 17, this enables the inlet valve 60 to return to its closed state. For this purpose, the valve member of the inlet valve 60 is pre-tensioned in the closed state. The operating lever 9 is similarly pre-tensioned by a spring. The operating lever 9 is pre-tensioned into the position in which the longitudinal end 62 does not actuate the inlet valve 60. The operating lever 9 has a lower longitudinal end 64. The lower longitudinal end 64 is facing towards the hand grip 11. The operating lever pivot axis 17 is arranged between the longitudinal end 62 and the lower longitudinal end 64. The longitudinal end 62 is also referred to as an upper longitudinal end 62.

The high-pressure cleaning device 1 comprises a switch 65. The switch 65 serves to switch the motor 3 on and off. In the exemplary embodiment, the switch 65 is a touch switch. In the exemplary embodiment, the switch 65 is a micro-switch. Depending on the position of the operating lever 9, the switch 65 is on or off. The switch 65 is connected to the control unit 33 via a signal line 66 illustrated in FIGS. 2, 3 and 10. In the exemplary embodiment, the signal line 66 is a cable. However, it can be provided that the signal line is a wireless connection.

A touch surface 67 is designed on the lower longitudinal end 64 of the operating lever 9, as illustrated in FIGS. 2 and 3. The switch 65 is actuated by means of the touch surface 67. In the exemplary embodiment, this takes place indirectly via a leaf spring 68. However, it can also be provided that the touch surface 67 directly actuates the switch 65. The lower longitudinal end 64 is pivoted in the opposite direction to the discharge direction 14 around the operating lever pivot axis 17 to actuate the switch 65. In this case, the lower longitudinal end 64 of the operating lever 9 presses the leaf spring 63 against the switch 65. The control unit 33 is informed via the signal line 66 that the switch 65 has been actuated. The control unit 33 switches on the motor 3. The motor 3 drives the pump 2 via the transmission 61. This supplies cleaning fluid. When the operating lever 9 is released, the leaf spring 67 acts and presses the operating lever 9 into its not actuated position. Then, the switch 65 is no longer actuated. This is transmitted to the control unit 33 via the signal line 66. The control unit 33 then switches the motor 3 off. No more cleaning fluid is supplied.

During operation, the control unit 33 controls the light source 32. When the control unit 33 sends a corresponding signal, in particular an electrical signal, to the light source 32, the light source 32 lights up. The light emitted by the light source 32 exits from the light emission surface 32 and enters the channel 40 through the light entry surface 46. In particular, the light enters the light guide arranged in the channel 40. The light is reflected for the most part at the interface between the light guide and the channel wall 45 and is therefore deflected back into the interior of the light guide. The light exits from the light guide at the outer longitudinal end 42 of the channel 40 and illuminates the display element 20, in particular the display surface 21. In the exemplary embodiment, the light guide is in direct contact with the display element 20.

The channel 40 extends out from the electronics module 30 substantially in the opposite direction to the discharge direction 14. In a side view, the longitudinal center axis 43 of the channel 40 having the discharge direction 14 makes an angle of less than 30°, in particular less than 20°, perpendicular to the hand grip longitudinal axis 19 and perpendicular to the discharge direction 14.

What is claimed is:

1. A high-pressure cleaning device (1), comprising:
a housing (10), the housing (10) having a housing outer wall (12);
a pump (2) for generating high pressure in a cleaning fluid and a motor (3) for driving the pump (2) arranged in the housing (10);
a display element (20) visible from outside the housing (10) in a region of the housing outer wall (12);
a light source (32) arranged in the housing (10) for illuminating the display element (20);
an electronics module (30) having an electronics housing (31) arranged in the housing (10); and
a control unit (33) arranged in the electronics housing (31),
wherein the light source (32) is arranged on the electronics module (30), and
wherein a channel (40) for guiding light from the light source (32) to the display element (20) is arranged between the electronics module (30) and the display element (20).

2. The high-pressure cleaning device according to claim 1,
wherein the electronics housing (31) is arranged in the housing (10) at a distance from the housing outer wall (12).

3. The high-pressure cleaning device according to claim 1,
wherein the channel (40) has an inner longitudinal end (41) coupled to the electronics housing (31),
wherein the channel (40) has an outer longitudinal end (42) coupled to the display element (20),
wherein the channel (40) encloses a longitudinal center axis (43) which runs through the outer longitudinal end (42) and the inner longitudinal end (41) in a longitudinal direction (44),
wherein the channel (40) has a channel length (L) measured in the longitudinal direction (44),
wherein the light source (32) has a light emission surface (34) which has a largest source extent (q), and wherein the channel length (L) is at least 200% of the largest source extent (q).

4. The high-pressure cleaning device according to claim 3,
wherein the channel length (L) is at least 10 mm.

5. The high-pressure cleaning device according to claim 1,
wherein the channel (40) connects the display element (20) to the light source (32) without interruption.

6. The high-pressure cleaning device according to claim 1,
wherein the channel (40) is hollow.

7. The high-pressure cleaning device according to claim 6, wherein a light guide is arranged in the channel (40).

8. The high-pressure cleaning device according to claim 1,
wherein the housing (10) comprises a discharge opening (13) for discharging the cleaning fluid from the housing (10) in a discharge direction (14),
wherein the housing (10) has a back end (15) lying opposite the discharge opening (13) in the direction opposite to the discharge direction (14), and
wherein the display element (20) is arranged in a region of the back end (15).

9. The high-pressure cleaning device according to claim 1,
wherein the motor (3) has a motor rotational axis (7), and
wherein the electronics housing (31) is arranged in a region of the motor (3) in relation to a direction of the motor rotational axis (7) and is arranged next to the motor (3) in relation to the motor rotational axis (7) in a radial direction (8).

10. The high-pressure cleaning device according to claim 1,
wherein the high-pressure cleaning device (1) comprises a hand grip (11),
wherein the motor (3) has an underside (51) facing towards the hand grip (11) and an upper side (52) facing away from the hand grip (11), and
wherein the electronics module (30) is arranged on the upper side (52) of the motor (3) facing away from the hand grip (11).

11. The high-pressure cleaning device according to claim 1,
wherein an operating element (4) is arranged on the housing (10),
wherein a function of the high-pressure cleaning device (1) can be controlled by the operating element (4) via the control unit (33), and
wherein the light source (32) can be controlled by the control unit (33), in order to display a status of the function by illuminating the display element (20).

12. The high-pressure cleaning device according to claim 11,
further comprising an actuating element (35),
wherein the actuating element (35) can be actuated mechanically by the operating element (4),
wherein the actuating element (35) sends a signal to the control unit (33), and
wherein the actuating element (35) is arranged in the electronics housing (31).

13. The high-pressure cleaning device according to claim 1,
wherein an operating lever (9) is arranged on the housing (10), the operating lever (9) being configured
for actuating the motor (3) and/or
for actuating an inlet valve (60) through which cleaning fluid can flow into the pump (2).

14. The high-pressure cleaning device according to claim 13,
wherein the operating lever (9) is arranged between the motor (3) and the inlet valve (60) in relation to a discharge direction (14).

15. The high-pressure cleaning device according to claim 14,
further comprising a transmission (61) for transmitting a torque from the motor (3) to the pump (2),
wherein the transmission (61) is arranged between the motor (3) and the pump (2) in relation to the discharge direction (14) of the cleaning fluid,
wherein the operating lever (9) has a longitudinal end (62), facing away from a hand grip (11),
wherein the longitudinal end (62) is arranged between the transmission (61) and the inlet valve (60) in relation to the discharge direction (14) for actuating the inlet valve (60).

16. The high-pressure cleaning device according to claim 1,
wherein the electronics housing (31) is arranged in the housing (10) at a distance from the display element (20).

17. The high-pressure cleaning device according to claim 1,
wherein the display element (20) is a component of the housing outer wall (12).
